(19) United States
(12) Patent Application Publication
(10) Pub. No.: US 2021/0366057 A1
(43) Pub. Date: Nov. 25, 2021

(54) INFORMATION SHARING SUPPORT DEVICE AND INFORMATION SHARING SUPPORT SYSTEM

(71) Applicant: Mitsubishi Electric Corporation, Tokyo (JP)

(72) Inventors: Reiko SAKATA, Tokyo (JP); Satoshi YAMAZAKI, Tokyo (JP); Shuhei SUZUKI, Tokyo (JP); Takashi NAKAHIRA, Tokyo (JP); Keisuke NAKAYAMA, Tokyo (JP); Naoki MAESAKA, Tokyo (JP)

(73) Assignee: Mitsubishi Electric Corporation, Tokyo (JP)

(21) Appl. No.: 17/394,461

(22) Filed: Aug. 5, 2021

Related U.S. Application Data
(63) Continuation of application No. PCT/JP2019/008377, filed on Mar. 4, 2019.

(51) Int. Cl. G06Q 50/04; B66B 5/00; G06F 16/16; G06F 16/23; G06F 16/2457

(52) U.S. Cl. CPC G06Q 50/04; B66B 5/0025; G06F 16/2457; G06F 16/2329; G06F 16/168

(57) ABSTRACT

An information sharing support device supports sharing of a plurality of pieces of sharing target information related to the development and the manufacture of a manufacturing target apparatus, the information sharing support device including: a tagging unit for attaching a tag selected from a plurality of tags to each of the plurality of pieces of sharing target information; and a sharing target information managing unit for managing the plurality of pieces of sharing target information in association with each other on the basis of the tag attached to each of the plurality of pieces of sharing target information, wherein the plurality of pieces of sharing target information includes basic sharing target information and additional sharing target information that is additionally input to the basic sharing target information by a staff member at a manufacturing site of the manufacturing target apparatus, and a tag attached to the additional sharing target information includes a tag attached to the basic sharing target information that corresponds to the additional sharing target information.

### CROSS-REFERENCE TO RELATED APPLICATION

The present application is a Continuation application of PCT Application PCT/JP2019/008377, filed Mar. 4, 2019, the entire contents of which are incorporated herein by reference.

### TECHNICAL FIELD

The present invention relates to an information sharing support device and an information sharing support system.

### BACKGROUND ART

In the related art, systems are developed which provide information to be used for elevator maintenance to a mechanic of the elevator (see, for example, Patent Literature 1).

### CITATION LIST

### Patent Literatures

Patent Literature 1: JP 2002-316779 A

### SUMMARY OF INVENTION

### Technical Problem

In the related art, systems are developed which provide information that a developer of an elevator has to a staff member at a manufacturing site of the elevator. As a result, the information that the developer of the elevator has can be shared between the staff member at the manufacturing site of the elevator and the developer of the elevator.

However, the conventional systems cannot feed back information acquired by the staff member at the manufacturing site of the elevator, that is, information acquired at the manufacturing site of the elevator to the developer of the elevator. Therefore, the information acquired at the manufacturing site of the elevator cannot be shared between the developer of the elevator and the staff member at the manufacturing site of the elevator. As a result, there is a problem that information sharing between a developer and a staff member at a manufacturing site is insufficient.

In addition, the conventional systems cannot manage information that a developer of the elevator has and information acquired at the manufacturing site of the elevator in association with each other. Therefore, there is a problem that the searchability of these pieces of information is low.

The present invention has been made to solve the problems as described above, and an object of the present invention is to promote the sharing of pieces of information regarding development and manufacture of an apparatus such as an elevator and to improve the searchability of these pieces of information.

### Solution to Problem

An information sharing support device of the present invention supports sharing of a plurality of pieces of sharing target information related to development and manufacture of a manufacturing target apparatus, the information sharing support device including: processing circuitry to attach a tag selected from a plurality of tags to each of the plurality of pieces of sharing target information; and to manage the plurality of pieces of sharing target information in association with each other on the basis of the tag attached to each of the plurality of pieces of sharing target information, wherein the plurality of pieces of sharing target information includes basic sharing target information and additional sharing target information that is additionally input to the basic sharing target information by a staff member at a manufacturing site of the manufacturing target apparatus, and a tag attached to the additional sharing target information includes a tag attached to the basic sharing target information that corresponds to the additional sharing target information.

### Advantageous Effects of Invention

According to the present invention configured as described above, it is possible to promote the sharing of pieces of information regarding development and manufacture of an apparatus such as an elevator and to improve the searchability of these pieces of information.

### BRIEF DESCRIPTION OF DRAWINGS

FIG. 1 is an explanatory diagram illustrating a system configuration of an information sharing support system according to a first embodiment.

FIG. 2 is a block diagram illustrating a main part of a first terminal device included in the information sharing support system according to the first embodiment.

FIG. 3 is a block diagram illustrating a main part of a second terminal device included in the information sharing support system according to the first embodiment.

FIG. 4 is a block diagram illustrating a main part of a server device included in the information sharing support system according to the first embodiment.

FIG. 5 is a block diagram illustrating a main part of an information sharing support device according to the first embodiment.

FIG. 6A is an explanatory diagram illustrating a hardware configuration of the information sharing support device according to the first embodiment.

FIG. 6B is an explanatory diagram illustrating another hardware configuration of the information sharing support device according to the first embodiment.

FIG. 7A is a flowchart illustrating the operation of the information sharing support device according to the first embodiment.

FIG. 7B is a flowchart illustrating another operation of the information sharing support device according to the first embodiment.

FIG. 7C is a flowchart illustrating another operation of the information sharing support device according to the first embodiment.

FIG. 7D is a flowchart illustrating another operation of the information sharing support device according to the first embodiment.

FIG. 7E is a flowchart illustrating another operation of the information sharing support device according to the first embodiment.

FIG. 8 is an explanatory diagram illustrating an example of a screen for a developer.

FIG. 9 is an explanatory diagram illustrating an example of a screen for an on-site staff member.

FIG. 10 is an explanatory diagram illustrating an example of another screen for an on-site staff member.

FIG. 11 is an explanatory diagram illustrating an example of another screen for an on-site staff member.

FIG. 12 is an explanatory diagram illustrating an example of another screen for a developer.

FIG. 13 is an explanatory diagram illustrating an example of another screen for an on-site staff member.

FIG. 14 is an explanatory diagram illustrating an example of another screen for a developer.

FIG. 15 is an explanatory diagram illustrating an example of another screen for a developer.

FIG. 16 is an explanatory diagram illustrating an example of an image projected by a projection device.

FIG. 17 is a block diagram illustrating a main part of another information sharing support device according to the first embodiment.

FIG. 18 is a block diagram illustrating a main part of another information sharing support device according to the first embodiment.

FIG. 19 is an explanatory diagram illustrating a system configuration of an information sharing support system according to a second embodiment.

FIG. 20 is a block diagram illustrating a main part of a server device included in the information sharing support system according to the second embodiment.

FIG. 21 is a block diagram illustrating a main part of an information sharing support device according to the second embodiment.

FIG. 22A is a flowchart illustrating the operation of the information sharing support device according to the second embodiment.

FIG. 22B is a flowchart illustrating another operation of the information sharing support device according to the second embodiment.

FIG. 23 is a block diagram illustrating a main part of another information sharing support device according to the second embodiment.

FIG. 24 is a block diagram illustrating a main part of another information sharing support device according to the second embodiment.

### DESCRIPTION OF EMBODIMENTS

To describe the present invention further in detail, embodiments for carrying out the present invention will be described below by referring to the accompanying drawings.

### First Embodiment

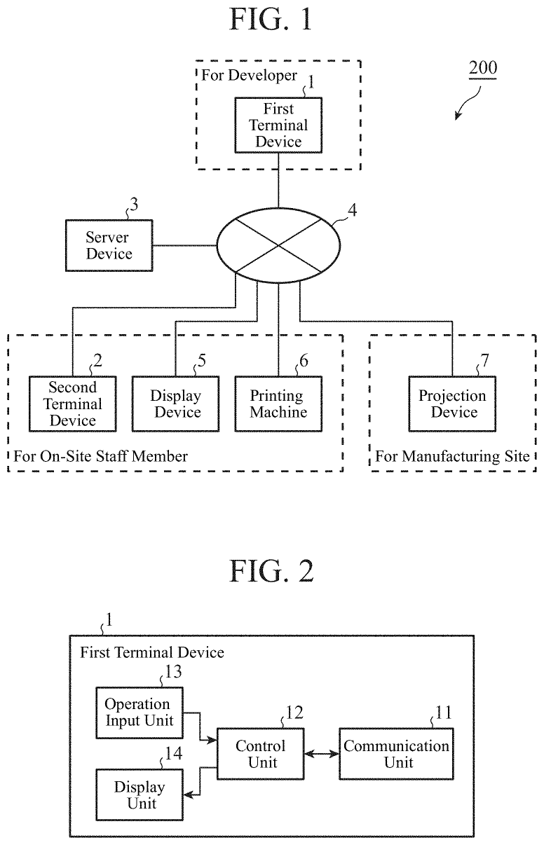

FIG. 1 is an explanatory diagram illustrating a system configuration of an information sharing support system according to a first embodiment. An information sharing support system 200 according to the first embodiment will be described by referring to FIG. 1.

The information sharing support system 200 supports the sharing of a plurality of pieces of information (hereinafter referred to as “sharing target information”) related to the development and the manufacture of an apparatus to be developed and manufactured (hereinafter referred to as a “manufacturing target apparatus”). The plurality of pieces of sharing target information may include any type of information as long as it pertains to the development and the manufacture of the manufacturing target apparatus.

For example, the plurality of pieces of sharing target information includes information indicating the specifications of a manufacturing target apparatus, information indicating the specifications of various articles (jigs, tools, parts, etc.) to be used for the manufacture of the manufacturing target apparatus, information indicating various manuals to be used for the manufacture of the manufacturing target apparatus, information indicating various drawings to be used in the development and the manufacture of the manufacturing target apparatus, information indicating various lists to be used in the manufacture of the manufacturing target apparatus, information indicating various procedures in the manufacture of the manufacturing target apparatus, information indicating various schedules in the manufacture of the manufacturing target apparatus, information indicating various reports in the manufacture of the manufacturing target apparatus, and basic information regarding the development and the manufacture of the manufacturing target apparatus. However, as described above, the plurality of pieces of sharing target information is not limited to these specific examples.

Hereinafter, a developer of a manufacturing target apparatus (including natural persons and corporations) may be simply referred to as a “developer”. Normally, a developer (natural person) is employed by a developer (corporation) and belongs to a development division of a manufacturing target apparatus of the developer (corporation). Hereinafter, the development division of the manufacturing target apparatus may be simply referred to as the “development division”. Usually, a development division includes a plurality of departments, and one or more developers (natural persons) belong to each of the plurality of departments.

Hereinafter, a staff member at a manufacturing site of the manufacturing target apparatus (including natural persons and corporations, and also including manufacturing staff members and sale staff members) may be simply referred to as the “on-site staff member”. Normally, an on-site staff member (natural person) is engaged in the manufacture of the manufacturing target apparatus at the manufacturing site of the manufacturing target apparatus under the direction and supervision of an on-site staff member (corporation). Hereinafter, the manufacturing site of the manufacturing target apparatus may be simply referred to as the “manufacturing site”. Normally, one or more on-site staff members (natural persons) are engaged in the manufacture of the manufacturing target apparatus at each of a plurality of manufacturing sites.

A manufacturing target apparatus is, for example, an elevator. Normally, an elevator is installed in a building and is assembled at a construction site of the building to which the elevator is installed. That is, the manufacturing site of an elevator corresponds to the assembly site of the elevator, the installation site of the elevator, and the construction site of a building to which the elevator is to be installed. In addition, the “manufacture” of an elevator refers to the assembly and the installation at a construction site. Hereinafter, an example in which the manufacturing target apparatus is an elevator will be mainly described. Hereinafter, in the drawings, an elevator may be described as “Ele”.

As illustrated in FIG. 1, the information sharing support system 200 includes a terminal device 1 for a developer (hereinafter referred to as the “first terminal device”), a terminal device 2 for an on-site staff member (hereinafter referred to as the “second terminal device”), and a server device 3. The first terminal device 1 includes, for example, a personal computer (PC) or a workstation. The second terminal device 2 includes, for example, a smartphone, a tablet PC, or smart glasses. The first terminal device 1 and the second terminal device 2 can each freely communicate with the server device 3 by a computer network 4.

The information sharing support system 200 may further include a display device 5 for the on-site staff member. The display device 5 includes, for example, a liquid crystal display or an organic electro luminescence (EL) display. The display device 5 can freely communicate with at least one of the second terminal device 2 or the server device 3 by the computer network 4.

The information sharing support system 200 may further include a printing machine 6 for the on-site staff member. The printing machine 6 includes, for example, a printer. The printing machine 6 can freely communicate with at least one of the second terminal device 2 or the server device 3 by the computer network 4.

The information sharing support system 200 may further include a projection device 7 for the manufacturing site. The projection device 7 includes, for example, a projector. The projection device 7 can freely communicate with at least one of the second terminal device 2 or the server device 3 by the computer network 4.

Next, the first terminal device 1 will be described by referring to FIG. 2.

As described above, the first terminal device 1 includes, for example, a PC or a workstation. Therefore, as illustrated in FIG. 2, the first terminal device 1 includes a communication unit 11, a control unit 12, an operation input unit 13, and a display unit 14.

The communication unit 11 includes, for example, a transmitter and a receiver for wired communication, or a transmitter and a receiver for wireless communication. The communication unit 11 can be freely connected to the computer network 4. The control unit 12 includes, for example, a processor and a memory, or a processing circuit. The operation input unit 13 includes, for example, a keyboard and a mouse. The display unit 14 includes, for example, a liquid crystal display or an organic EL display.

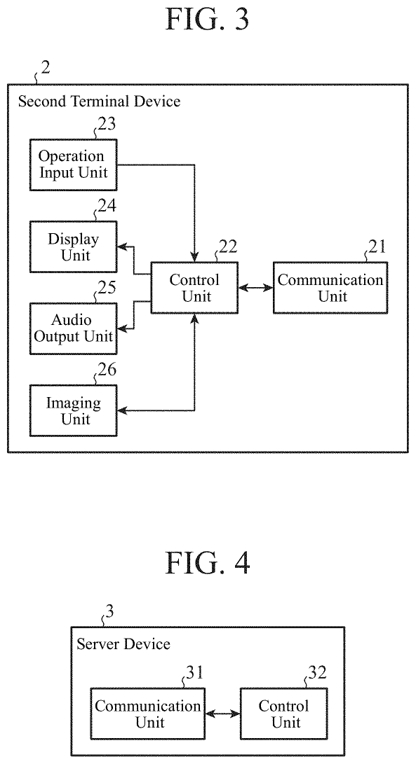

Next, the second terminal device 2 will be described by referring to FIG. 3.

As described above, the second terminal device 2 includes, for example, a smartphone, a tablet PC, or smart glasses. Therefore, as illustrated in FIG. 3, the second terminal device 2 includes a communication unit 21, a control unit 22, an operation input unit 23, a display unit 24, an audio output unit 25, and an imaging unit 26.

The communication unit 21 includes, for example, a transmitter and a receiver for wireless communication. The communication unit 21 can be freely connected to the computer network 4. The control unit 22 includes, for example, a processor and a memory, or a processing circuit. The operation input unit 23 includes, for example, at least one of a touch panel, a hardware button, or a microphone for audio input. The display unit 24 includes, for example, a liquid crystal display, an organic EL display, or a spectacles-shaped head-up display (HUD). The audio output unit 25 includes, for example, a speaker. The imaging unit 26 includes, for example, a visible light camera.

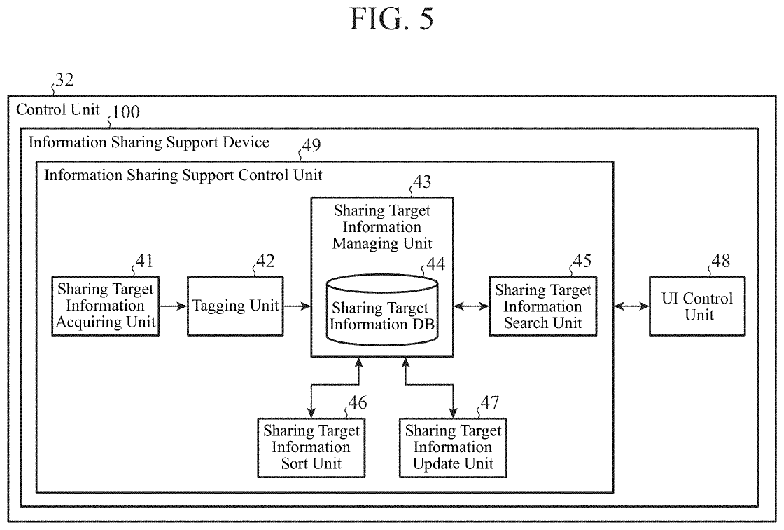

Next, the server device 3 will be described by referring to FIG. 4. Furthermore, an information sharing support device 100 according to the first embodiment will be described by referring to FIG. 5.

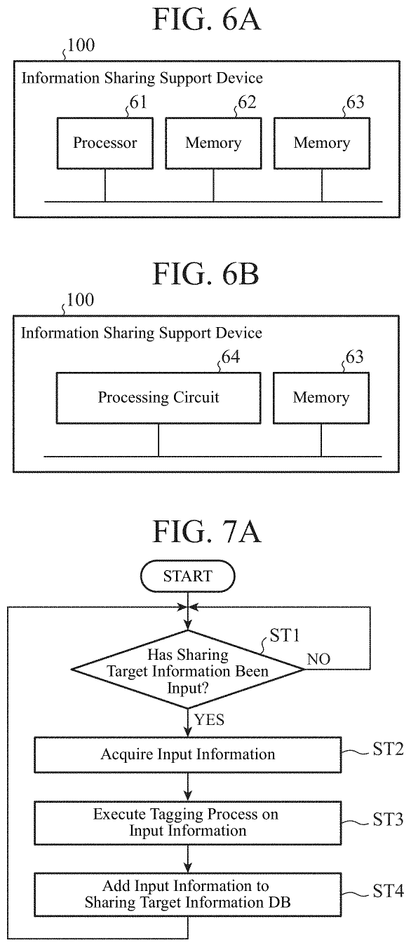

As illustrated in FIG. 4, the server device 3 includes a communication unit 31 and a control unit 32. The communication unit 31 includes, for example, a transmitter and a receiver for wired communication, or a transmitter and a receiver for wireless communication. The communication unit 31 can be freely connected to the computer network 4. The control unit 32 includes, for example, a processor 61 and memories 62 and 63, or a processing circuit 64 and the memory 63. The hardware configuration of the control unit 32 will be described later by referring to FIG. 6.

The control unit 12 of the first terminal device 1 controls the operation of the entire first terminal device 1. The control unit 22 of the second terminal device 2 controls the operation of the entire second terminal device 2. The control unit 32 of the server device 3 controls the operation of the entire server device 3. The control units 12 and 32 can cooperate with each other by communication between the communication units 11 and 31. The control units 22 and 32 can cooperate with each other by communication between the communication units 21 and 31. Through these controls and cooperation, the control unit 32 of the server device 3 implements functions that correspond to respective units described below.

When any one or more of the plurality of pieces of sharing target information is input to the first terminal device 1 by the developer, a sharing target information acquiring unit 41 acquires the sharing target information that has been input. Hereinafter, the sharing target information that is to be input, that is, the sharing target information that has been input may be referred to as “first input information”. In addition, hereinafter, a person who inputs the first input information among developers, that is, a person who has input the first input information among developers may be referred to as a “first inputter”.

In addition, when any one or more of the plurality of pieces of sharing target information is input to the second terminal device 2 by an on-site staff member, the sharing target information acquiring unit 41 also acquires the sharing target information that has been input. Hereinafter, the sharing target information that is to be input, that is, the sharing target information that has been input may be referred to as “second input information”. In addition, hereinafter, a person who inputs the second input information among on-site staff members, that is, a person who has input the second input information among on-site staff members may be referred to as a “second inputter”.

Hereinafter, the first input information and the second input information may be collectively referred to as “input information”. In addition, hereinafter, the first inputter and the second inputter may be collectively referred to as “inputter”.

A tagging unit 42 executes a process of attaching one or more selected tags among a plurality of tags to individual pieces of input information acquired by the sharing target information acquiring unit 41 (hereinafter referred to as a “tagging process”). The plurality of tags may include a tag indicating any matter as long as the tag indicates a matter related to the development and the manufacture of the manufacturing target apparatus.

For example, the plurality of tags includes a tag indicating the attribute of a person who can view the information to which the tag is attached, a tag indicating matters related to the elevator (model, model name, ascending and descending speed, capacity, the door opening and closing method, the layout, options, etc.) corresponding to the information to which the tag is attached, a tag indicating matters related to the building (construction method, process, property, etc.) corresponding to the information to which the tag is attached, and a tag indicating matters related to articles (jigs, tools, parts, etc.) to be used in the manufacture of the elevator corresponding to the information to which the tag is attached. However, as described above, the plurality of tags is not limited to these specific examples. Hereinafter, in the drawings, a model name of an elevator may be described as “code”.

A tag attached to individual first input information may include a tag automatically selected by the tagging unit 42 among the plurality of tags. Similarly, a tag attached to individual second input information may include a tag automatically selected by the tagging unit 42 among the plurality of tags. That is, the tagging unit 42 may have a function of automatically selecting a tag to be attached to individual input information.

Furthermore, a tag attached to individual first input information may include a tag selected by operation input to the first terminal device 1 by the first inputter among the plurality of tags. Similarly, a tag attached to individual second input information may include a tag selected by operation input to the second terminal device 2 by the second inputter among the plurality of tags. That is, a tag attached to individual input information may include a tag selected by an inputter among the above-mentioned plurality of tags.

In addition to tags that are prestored in the tagging unit 42 (hereinafter, may be referred to as “initial tags”), the plurality of tags may include tags that are additionally generated by the tagging unit 42 (hereinafter, also referred to as “additional tags”). That is, the tagging unit 42 may have a function of generating an additional tag.

For example, a tag indicating the date and time when individual input information is input may be generated by the function and automatically attached by the tagging unit 42. Furthermore, for example, a tag indicating the manufacturing site corresponding to individual second input information among a plurality of manufacturing sites may be generated by the function and automatically attached by the tagging unit 42 on the basis of the position coordinates of the second terminal device 2 at the time when the individual second input information has been input.

A sharing target information managing unit 43 manages pieces of input information in association with each other on the basis of the tags attached to individual input information by the tagging unit 42. More specifically, the sharing target information managing unit 43 generates and stores a database 44 in which these pieces of input information are associated with each other (hereinafter referred to as a “sharing target information database”) on the basis of the tags attached to individual input information. When the sharing target information acquiring unit 41 acquires new input information, and the tagging unit 42 attaches a tag to the new input information, the sharing target information managing unit 43 adds the new input information to the sharing target information database 44 and further adds information indicating the tag attached to the new input information to the sharing target information database 44. Hereinafter, the database may be referred to as “DB” in the drawings.

A sharing target information search unit 45 executes a process of a so-called “refined search” (hereinafter, “search process”) on sharing target information in the sharing target information database 44 (that is, input information of the past) on the basis of a tag attached to individual input information. The search process is executed, for example, when an operation instructing execution of the search process is input to the second terminal device 2 by the on-site staff member, in response to the operation that has been input.

A sharing target information sort unit 46 executes a process of sorting one or more pieces of sharing target information included in the result of the search process by the sharing target information search unit 45 on the basis of a tag attached to individual input information (hereinafter, referred to as a “sort process”). The sort process is executed, for example, when an operation instructing execution of the sort process is input to the second terminal device 2 by the on-site staff member, in response to the operation that has been input.

A sharing target information update unit 47 executes a process of updating some pieces of the sharing target information (hereinafter referred to as “update target information”) in the sharing target information database 44 (hereinafter referred to as a “normal update process”). The normal update process is executed, for example, when an operation instructing execution of the normal update process is input to the first terminal device 1 by the developer, in response to the operation that has been input.

The sharing target information update unit 47 executes a process of updating, in addition to the update target information, one or more pieces of sharing target information that are associated with the update target information among the sharing target information in the sharing target information database 44 on the basis of a tag attached to individual input information (hereinafter referred to as a “batch update process”). The batch update process is executed, for example, when an operation instructing execution of the batch update process is input to the first terminal device 1 by the developer, in response to the operation that has been input.

A user interface control unit 48 executes control for displaying various screens for the developer on the display unit 14 of the first terminal device 1 and also controls the user interface by these screens. The user interface control unit 48 executes control for displaying various screens for the on-site staff member on the display unit 24 of the second terminal device 2 and also controls the user interface by these screens.

In addition to the above, the user interface control unit 48 may also execute control for displaying various screens for the on-site staff member on the display device 5 and also control the user interface by these screens. Furthermore, the user interface control unit 48 may execute control for causing the projection device 7 to project various images for the manufacturing site. Hereinafter, in the drawings, the user interface may be referred to as “UI”.

The sharing target information acquiring unit 41, the tagging unit 42, the sharing target information managing unit 43, the sharing target information search unit 45, the sharing target information sort unit 46, and the sharing target information update unit 47 are included in the main part of an information sharing support control unit 49. The user interface control unit 48 and the information sharing support control unit 49 are included in the main part of the control unit 32. Meanwhile, the user interface control unit 48 and the information sharing support control unit 49 are included in the main part of the information sharing support device 100.

Next, by referring to FIG. 6, the hardware configuration of the main part of the control unit 32, that is, the hardware configuration of the main part of the information sharing support device 100 will be described.

As illustrated in FIG. 6A, the information sharing support device 100 includes the processor 61, the memory 62, and the memory 63. The memory 62 stores programs that correspond to the functions of the sharing target information acquiring unit 41, the tagging unit 42, the sharing target information managing unit 43, the sharing target information search unit 45, the sharing target information sort unit 46, the sharing target information update unit 47, and the user interface control unit 48. When the processor 61 reads and executes the programs that are stored, the functions of the sharing target information acquiring unit 41, the tagging unit 42, the sharing target information managing unit 43, the sharing target information search unit 45, the sharing target information sort unit 46, the sharing target information update unit 47, and the user interface control unit 48 are implemented. However, the function of the sharing target information database 44 of the sharing target information managing unit 43 is implemented by the memory 63.

Alternatively, as illustrated in FIG. 6B, the information sharing support device 100 includes the memory 63 and the processing circuit 64. In this case, the functions of the sharing target information acquiring unit 41, the tagging unit 42, the sharing target information managing unit 43, the sharing target information search unit 45, the sharing target information sort unit 46, the sharing target information update unit 47, and the user interface control unit 48 are implemented by the dedicated processing circuit 64. However, the function of the sharing target information database 44 of the sharing target information managing unit 43 is implemented by the memory 63.

Alternatively, the information sharing support device 100 includes the processor 61, the memory 62, the memory 63, and the processing circuit 64 (not illustrated). In this case, some of the functions of the sharing target information acquiring unit 41, the tagging unit 42, the sharing target information managing unit 43, the sharing target information search unit 45, the sharing target information sort unit 46, the sharing target information update unit 47, and the user interface control unit 48 are implemented by the processor 61 and the memory 62, and the remaining functions are implemented by the dedicated processing circuit 64. However, the function of the sharing target information database 44 of the sharing target information managing unit 43 is implemented by the memory 63.

The processor 61 includes, for example, at least one of a central processing unit (CPU), a graphics processing unit (GPU), a microprocessor, a micro control unit, or a digital signal processor (DSP).

The memory 62 includes a volatile memory and a non-volatile memory. The volatile memory of the memory 62 includes, for example, a random access memory (RAM). The non-volatile memory of the memory 62 includes, for example, at least one of a read only memory (ROM), a flash memory, an erasable programmable read only memory (EPROM), an electrically erasable programmable read-only memory (EEPROM), a solid state drive (SSD), or a hard disk drive (HDD).

The memory 63 includes a non-volatile memory. Specifically, for example, the memory 63 includes at least one of a ROM, a flash memory, an EPROM, an EEPROM, an SSD, or an HDD.

The processing circuit 64 includes, for example, at least one of an application specific integrated circuit (ASIC), a programmable logic device (PLD), a field-programmable gate array (FPGA), a system-on-a-chip (SoC), or a system large-scale integration (LSI).

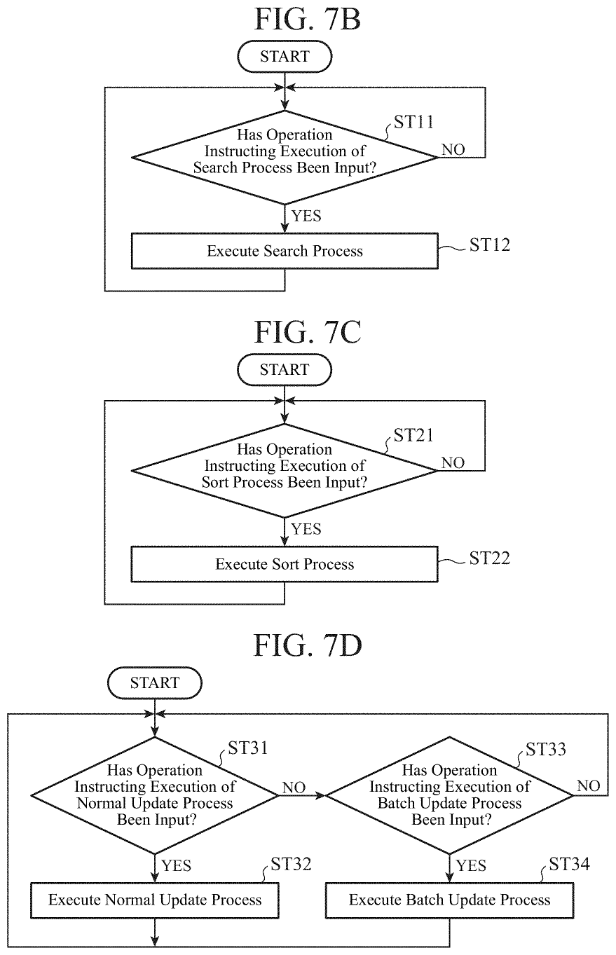

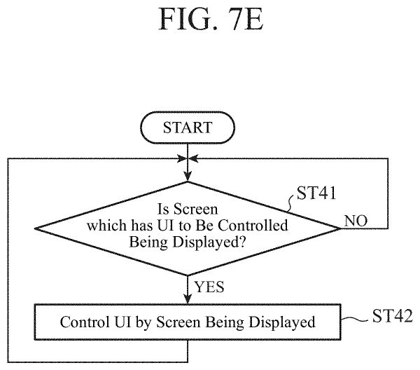

Next, by referring to flowcharts of FIG. 7, the operation of the information sharing support device 100 will be described.

FIG. 7A is illustrating the operation of the sharing target information acquiring unit 41, the tagging unit 42, and the sharing target information managing unit 43. As illustrated in FIG. 7A, if the first input information is input to the first terminal device 1 or if the second input information is input to the second terminal device 2 (“YES” in step ST1), the sharing target information acquiring unit 41 acquires the input information that has been input (step ST2). Next, the tagging unit 42 executes a tagging process on the input information that has been acquired (step ST3). Next, the sharing target information managing unit 43 adds the input information that has been acquired to the sharing target information database 44 (step ST4). At this time, the sharing target information managing unit 43 adds information indicating a tag attached to the input information that has been acquired to the sharing target information database 44 together with the input information that has been acquired.

FIG. 7B illustrates the operation of the sharing target information search unit 45. As illustrated in FIG. 7B, if an operation instructing execution of the search process is input to the second terminal device 2 (“YES” in step ST11), the sharing target information search unit 45 executes the search process (step ST12).

FIG. 7C is illustrating the operation of the sharing target information sort unit 46. As illustrated in FIG. 7C, if an operation instructing execution of the sort process is input to the second terminal device 2 (“YES” in step ST21), the sharing target information sort unit 46 executes the sort process (step ST22).

FIG. 7D illustrates the operation of the sharing target information update unit 47. As illustrated in FIG. 7D, if an operation instructing execution of the normal update process is input to the first terminal device 1 (“YES” in step ST31), the sharing target information update unit 47 executes the normal update process (step ST32). On the contrary, if an operation instructing execution of the batch update process is input to the first terminal device 1 (“NO” in step ST31 and “YES” in step ST33), the sharing target information update unit 47 executes the batch update process (step ST34).

FIG. 7E is illustrating the operation of the user interface control unit 48. As illustrated in FIG. 7E, if a screen which has a user interface to be controlled by the user interface control unit 48 is displayed on the first terminal device 1, the second terminal device 2, or the display device 5 (“YES” in step ST41), the user interface control unit 48 controls the user interface by the screen that is displayed (step ST42). Note that the screen is displayed on the first terminal device 1, the second terminal device 2, or the display device 5 under the control of the user interface control unit 48.

Next, examples of works performed by the developer and examples of works performed by the on-site staff member will be described. In addition, examples of input information by these works will be described.

First, the developer develops specifications of an individual elevator and further develops specifications of various articles (jigs, tools, parts, etc.) to be used in the manufacture of the elevator. The developer inputs information indicating the specifications that have been developed (hereinafter, may be referred to as “specification information”) to the first terminal device 1. In the information sharing support system 200, the specification information is stored in the sharing target information database 44 as sharing target information (more specifically, first input information).

In addition, the developer prepares various manuals to be used for the manufacture of a corresponding elevator, for every manufacturing site. The developer inputs information indicating the manuals that have been prepared (hereinafter, may be referred to as “manual information”) to the first terminal device 1. In the information sharing support system 200, the manual information is stored in the sharing target information database 44 as sharing target information (more specifically, first input information).

Hereinafter, information such as specification information and manual information may be collectively referred to as “specification and other information”. In addition, specifications indicated by specification information and manuals indicated by manual information may be collectively referred to as “specifications, etc.”

In addition, the developer prepares or acquires various drawings to be used for the development of individual elevators. In addition, the developer prepares or acquires various drawings to be used for the manufacture of a corresponding elevator, for every manufacturing site. The developer inputs information indicating the drawings that have been prepared or acquired (hereinafter, may be referred to as “drawing information”) to the first terminal device 1. In the information sharing support system 200, the drawing information is stored in the sharing target information database 44 as sharing target information (more specifically, first input information).

In addition, the developer or the on-site staff member prepares various lists to be used for the manufacture of a corresponding elevator, for every manufacturing site. The developer or the on-site staff member inputs information indicating the lists that have been prepared (hereinafter, may be referred to as “list information”) to the first terminal device 1 or the second terminal device 2. In the information sharing support system 200, the list information is stored in the sharing target information database 44 as sharing target information (more specifically, first input information or second input information).

In addition, the developer or the on-site staff member develops various procedures for the manufacture of a corresponding elevator, for every manufacturing site. The developer or the on-site staff member inputs information indicating the procedures that have been developed (hereinafter, may be referred to as “procedure information”) to the first terminal device 1 or the second terminal device 2. In the information sharing support system 200, the procedure information is stored in the sharing target information database 44 as sharing target information (more specifically, first input information or second input information).

Hereinafter, the drawing information, the list information, the procedure information, and the like may be collectively referred to as “drawing and other information”. In addition, the drawings indicated by the drawing information, the list indicated by the list information, the procedure indicated by the procedure information, and the like may be collectively referred to as “drawings and the like”.

In addition, the developer or the on-site staff member creates various schedules for the manufacture of a corresponding elevator, for every manufacturing site. The developer or the on-site staff member inputs information indicating the schedules that have been created (hereinafter, may be referred to as “schedule information”) to the first terminal device 1 or the second terminal device 2. In the information sharing support system 200, the schedule information is stored in the sharing target information database 44 as sharing target information (more specifically, first input information or second input information).

In addition, the developer conducts a theoretical examination for a field survey before the start of the manufacture, for every manufacturing site. The developer inputs various types of information generated or acquired by the theoretical examination, information indicating the result of the theoretical examination, and other information (hereinafter, may be collectively referred to as “theoretical examination information”) to the first terminal device 1. In the information sharing support system 200, the theoretical examination information is stored in the sharing target information database 44 as sharing target information (more specifically, first input information). Note that the theoretical examination information may include information such as the drawing and other information and the schedule information.

In addition, the on-site staff member conducts a field survey before the start of manufacturing, for every manufacturing site. The on-site staff member inputs various types of information generated or acquired by the field survey, information indicating the result of the field survey, and other information (hereinafter, may be collectively referred to as “field survey information”) to the second terminal device 2. In the information sharing support system 200, the field survey information is stored in the sharing target information database 44 as sharing target information (more specifically, second input information).

In addition, the on-site staff member inputs information related to a matter that has occurred during the manufacture of an elevator and that is to be reported to the developer or another on-site staff member (hereinafter, may be referred to as “report information”) to the second terminal device 2, for every manufacturing site. In the information sharing support system 200, the report information is stored in the sharing target information database 44 as sharing target information (more specifically, second input information).

The report information includes, for example, information related to a defect that has occurred at individual manufacturing sites, information related to precautions that have occurred at individual manufacturing sites, information related to improvements of an elevator or a building that have been performed at individual manufacturing sites, or information related to schedule revisions made at individual manufacturing sites. In addition, the report information may include a picture of a place where the defect has occurred or a picture of a place where the improvement has been performed. These pictures are taken by, for example, the imaging unit 26 of the second terminal device 2.

In addition, the developer examines countermeasures against defects by using the report information accumulated in the sharing target information database 44. The developer inputs information indicating the process of the examination of countermeasures and information indicating the result of the examination of countermeasures (hereinafter, may be collectively referred to as “countermeasure examination information”) to the first terminal device 1. In the information sharing support system 200, the countermeasure examination information is accumulated in the sharing target information database 44 as sharing target information (more specifically, first input information).

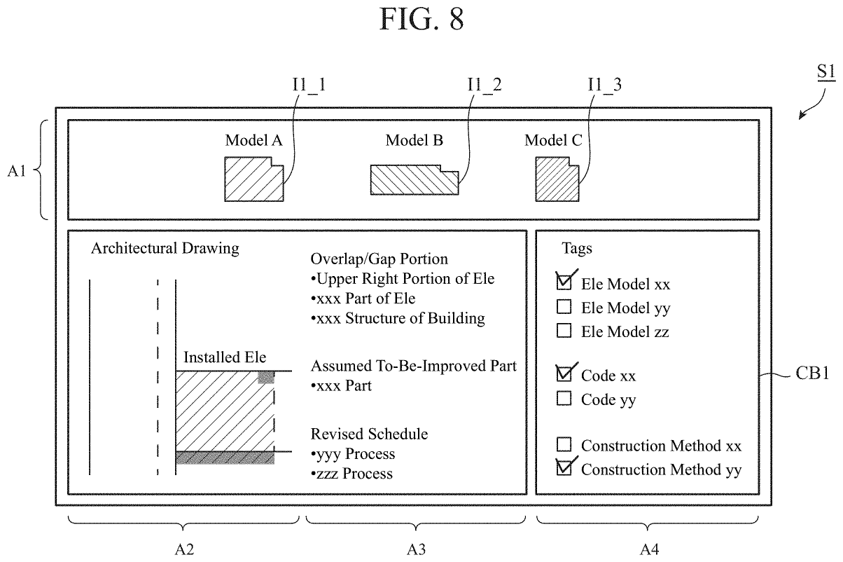

In the information sharing support system 200, various screens for inputting these pieces of information and various screens for displaying these pieces of information are displayed on the first terminal device 1, the second terminal device 2, the display device 5, or the like. The control for displaying these screens and the control of the user interface by these screens are executed by the user interface control unit 48 as described above. Hereinafter, examples of these screens and an example of the user interface by these screens will be described by referring to FIGS. 8 to 15.

FIG. 8 is a diagram illustrating an example of a screen S1 for input at the time of a theoretical examination in the first terminal device 1.

Before or during the theoretical examination, the developer prepares or acquires a drawing of a building where installation is to be performed. The developer inputs information indicating the drawing that has been prepared or acquired (that is, drawing information) to the first terminal device 1.

In the theoretical examination, the developer selects the elevator model to be installed. Normally, the shape of an elevator is different for each elevator model. The user interface control unit 48 causes images I1_1 to I1_3 illustrating the shapes of elevators of respective models to be displayed side by side in an area A1 in the screen S1. The developer selects an elevator model to be installed by operation input to the area A1. The tagging unit 42 automatically attaches a tag indicating the model that has been selected to the information included in the screen S1, that is, theoretical examination information. In addition, the tagging unit 42 automatically attaches a tag indicating a model name corresponding to the model that has been selected, a tag indicating a construction method corresponding to the model that has been selected, and the like to the theoretical examination information. Information indicating the correspondence relationship among the model, the model name, the construction method, and the like (so-called “preset information”) is prestored in, for example, the server device 3.

Note that one or more piece of sharing target information among the plurality of pieces of sharing target information (for example, information displayed in an area A3 among an area A2 and the area A3) may be generated by the control unit 32. The tagging unit 42 executes, on the sharing target information generated by the control unit 32, a tagging process similar to the tagging process for the input information.

Furthermore, the user interface control unit 48 causes check boxes CB1 for tag selection to be displayed in an area A4 in the screen S1. As described above, the tagging unit 42 automatically attaches, to the information included in the screen S1, a tag indicating the model selected by the operation input to the area A1, a tag indicating the model name corresponding to the model that has been selected, and a tag indicating the construction method corresponding to the model that has been selected. On the other hand, the developer can add or delete the tag attached to the information by operation input to the area A4.

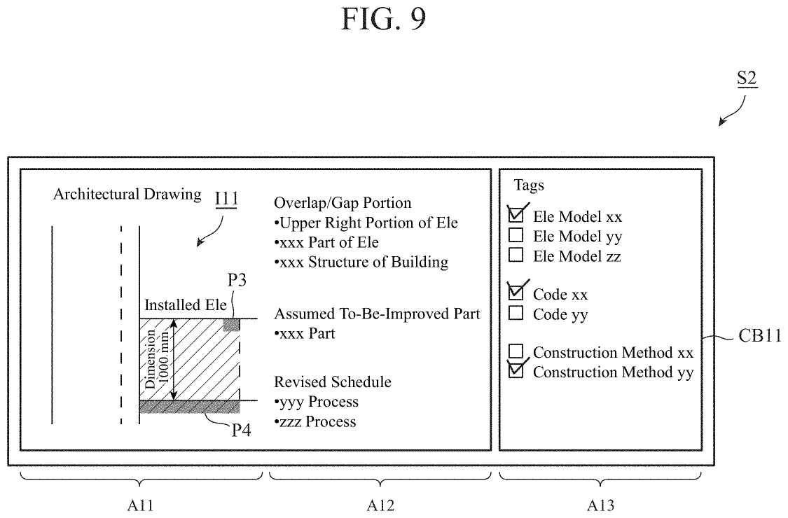

FIG. 9 is a diagram illustrating an example of a screen S2 for input at the time of a field survey in the second terminal device 2.

Normally, at the time when a field survey is conducted, information such as theoretical examination information and drawing information has already been input. Hereinafter, these pieces of sharing target information that have already been input may be referred to as “basic sharing target information”.

The user interface control unit 48 causes an image I11 obtained by superimposing a drawing of an elevator to be installed over a drawing of a building where installation is to be performed to be displayed in an area A11 in the screen S2, by using the basic sharing target information. Here, the image in the area A11 can be freely edited by operation input to the second terminal device 2. As a result, the on-site staff member can additionally input a value acquired by the field survey (for example, measured values of the dimensions) to the image I11. In addition, in a case where there is a discrepancy between a result of a theoretical examination and the result of the field survey, the on-site staff member can revise a line included in the image I11 in accordance with the discrepancy.

Note that, in the image I11, a portion where a gap is formed between a structure of the building and the elevator (P3 in the figure) may be highlighted. Moreover, a portion where a structure of the building and the elevator are arranged while superimposed (P4 in the figure) may be highlighted.

Furthermore, the control unit 32 may prepare an improvement plan for the building or the elevator on the basis of revisions to the image I11. Furthermore, in this case, the control unit 32 may prepare a revised plan of the schedule at the manufacturing site on the basis of the improvement plan that has been prepared. The user interface control unit 48 may cause information related to the improvement plan or the revised plan that has been prepared to be displayed in an area A12 in the screen S2. That is, the improvement plan and the revised plan in this case deal with the discrepancy between the result of the theoretical examination and the result of the field survey.

Here, information which is to be input using the screen S2, that is, the field survey information includes information that is to be additionally input to the basic sharing target information as described above. Hereinafter, the information that is to be additionally input, that is, the information that is additionally input may be referred to as “additional sharing target information”.

The tagging unit 42 automatically attaches the same tag as the tag attached to the basic sharing target information to the additional sharing target information. As a result, it is possible to eliminate the need of operation of selecting a tag by the on-site staff member during a field survey. Note that the tagging unit 42 may include a function of enabling basic sharing target information and additional sharing target information to be associated with each other by automatically sharing a tag of the original information.

However, the user interface control unit 48 may cause check boxes CB11 for tag selection to be displayed in an area A13 in the screen S2. In this case, the on-site staff member can add or delete a tag to be attached to additional sharing target information to or from a tag attached to basic sharing target information, by using the check boxes CB11. Here, it is preferable to allow the additional sharing target information and the basic sharing target information to always share some tags, by, for example, separating tags attached to the basic sharing target information into “required tags” and “modifiable tags” and displaying only the “modifiable tags” in the check boxes CB11 for tag selection, since this allows the basic sharing target information and the additional sharing target information to be always associated with each other.

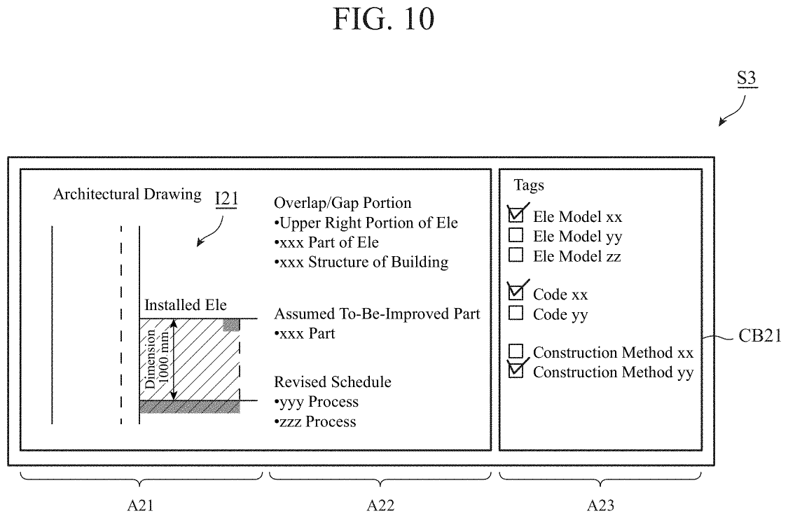

FIG. 10 is a diagram illustrating an example of a screen S3 displaying a result of a field survey in the second terminal device 2. That is, the screen S3 is a screen displayed on the second terminal device 2 after the field survey.

The user interface control unit 48 causes an image I21 that corresponds to the image I11 in the screen S2 to be displayed in an area A21 in the screen S3. The image I21 is obtained by reflecting revisions and additions to the image I11.

In addition, in a case where an improvement based on the above-described improvement plan and a revision based on the above-described revised plan are performed during or after the field survey, information indicating that fact (that is, second input information) has already been input by the on-site staff member. In this case, the user interface control unit 48 may cause information related to the improvement and the revision that have been performed to be displayed in an area A22 in the screen S3.

Furthermore, the user interface control unit 48 may cause check boxes CB21 indicating tags attached to information included in the screen S3 to be displayed in an area A23 in the screen S3. As a result, the on-site staff member can visually recognize the tags attached to the information.

Moreover, the screen S3 may be displayed on another terminal device (not illustrated) for the on-site staff member in place of or in addition to the second terminal device 2. Furthermore, the screen S3 may be displayed on the display device 5 in place of the second terminal device 2.

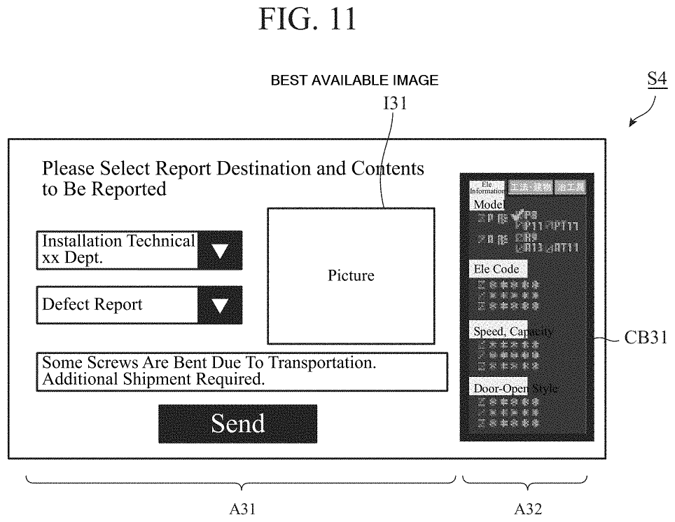

FIG. 11 is a diagram illustrating an example of a screen S4 for input during manufacture in the second terminal device 2. More specifically, the screen S4 is for inputting report information.

The user interface control unit 48 causes the screen S4 to be displayed on the second terminal device 2 when an operation instructing the display of the screen S4 is input to the second terminal device 2. The on-site staff member inputs the content of a report and sets the report destination by input operation on an area A31 in the screen S4. By pressing the “Send” button in the figure, information including this content, that is, report information is transmitted to the server device 3. In the example illustrated in FIG. 11, report information regarding a defect is transmitted to the server device 3.

At this time, the tagging unit 42 automatically attaches, to the report information, tags such as a tag indicating the elevator model in which the defect has occurred, a tag indicating the model name of the elevator in which the defect has occurred, a tag indicating the construction method in which the defect has occurred, and a tag indicating a manufacturing process in which the defect has occurred. The tags that are attached are selected on the basis of information such as information included in the screen that has been displayed before the screen S4 is displayed on the second terminal device 2 and schedule information in the sharing target information database 44. That is, in the information sharing support system 200, these pieces of information are also sharing target information and are tagged. Therefore, by referring to the tags attached to these pieces of information, or by referring to information to which the same tags as those attached to these pieces of information are attached, it is possible to determine the elevator model in which the defect has occurred, the model name of the elevator in which the defect has occurred, the construction method in which the defect has occurred, the manufacturing process in which the defect occurred, and the like.

However, the user interface control unit 48 may cause check boxes CB31 for tag selection to be displayed in an area A32 in the screen S4. This allows the on-site staff member to add or delete a tag to be attached to the report information.

In addition, as illustrated in FIG. 11, the screen S4 has a function of uploading a picture 131 of the defect part to the server device 3. The picture 131 is imaged by, for example, the imaging unit 26 of the second terminal device 2.

Note that a report using the screen S4 may be executed in response to a report request to the on-site staff member by the developer. In this case, the tags attached to report information may have been selected by the developer before the screen S4 is displayed (for example, when the report is requested).

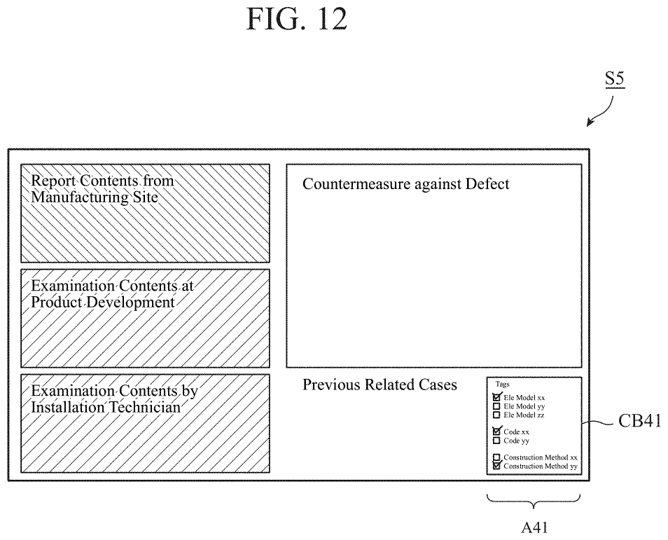

FIG. 12 is a diagram illustrating an example of a screen S5 for input at the time when a countermeasure against a defect is examined in the first terminal device 1.

The developer inputs countermeasure examination information by input operation on the screen S5. The tagging unit 42 automatically selects a tag that enables the countermeasure examination information to be referred to as a history and attaches the selected tag to the countermeasure examination information. As a result, the on-site staff member can view the examination process and the examination result of countermeasures by the developer for defects that have occurred in the past as a history by using the second terminal device 2.

However, the user interface control unit 48 may cause check boxes CB41 for tag selection to be displayed in an area A41 in the screen S5. This allows the developer to add or delete a tag to be attached to the countermeasure examination information.

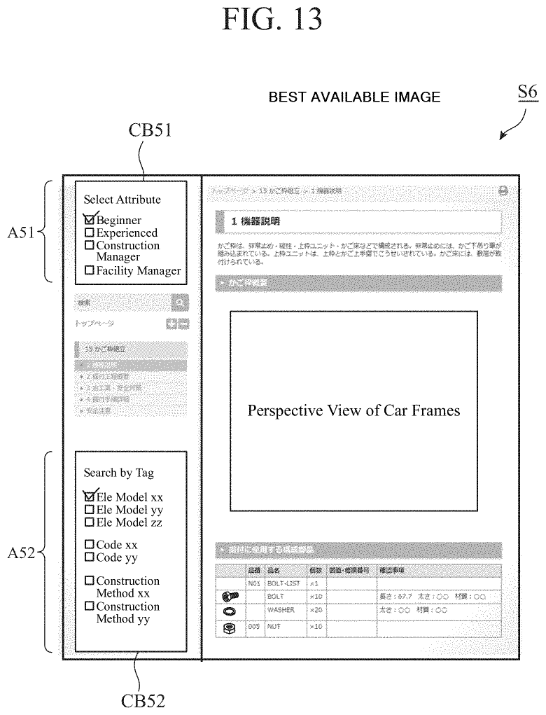

FIG. 13 is a diagram illustrating an example of a screen S6 for displaying specifications and the like in the second terminal device 2.

The user interface control unit 48 has a function of causing the screen S6 including specification and other information in the sharing target information database 44 to be displayed on the second terminal device 2. In principle, the screen S6 includes all specification and other information in the sharing target information database 44. Furthermore, on the screen S6, in principle, pieces of the specification and other information are arranged in an order based on the manufacturing process of each elevator. This arrangement is implemented because tags such as a tag indicating a corresponding elevator model, a tag indicating the model name of the corresponding elevator, a tag indicating a corresponding construction method, and a tag indicating a corresponding manufacturing process are attached to each piece of the specification and other information.

Here, the user interface control unit 48 causes check boxes CB51 for selecting the attribute of a viewer of the screen S6 to be displayed in an area AM on the screen S6. The user interface control unit 48 has a function of setting, depending on the attribute selected by the check boxes CB51, whether or not to display or the display mode of each piece of the specification and other information on the screen S6 by using tags.

That is, each of a plurality of attributes included in the check boxes CB51 corresponds to one or more tags among the plurality of tags. The user interface control unit 48 includes, in the display target on the screen S6, information to which a tag corresponding to a selected attribute is attached and which is among the specification and other information, and excludes the remaining information of the specification and other information from the display target on the screen S6. Alternatively, the user interface control unit 48 causes the information to which the tag corresponding to the selected attribute is attached and which is among the specification and other information to be highlighted on the screen S6, and causes the remaining information of the specification and other information to be unhighlighted (for example, grayed out) on the screen S6. As a result, for example, display as the following is implemented.

For example, in a case where the “Experienced” attribute is selected in the figure, only the information including the applied content (for example, information related to specifications and the like that are unique to each manufacturing site) among the specification and other information is displayed on the screen S6.

Alternatively, for example, in a case where the attribute “beginner” is selected in the figure, information including the basic content (for example, information related to common specifications and the like at a plurality of manufacturing sites) among the specification and other information is displayed on the screen S6, and the information including the applied content among the specification and other information is excluded from the screen S6. Alternatively, in this case, the information including the basic content among the specification and other information is highlighted on the screen S6, and the information including the applied content among the specification and other information is unhighlighted on the screen S6.

Alternatively, for example, when the “Construction Manager” attribute is selected in the figure, information related to the construction at the manufacturing site among the specification and other information is displayed on the screen S6, and the remaining information of the specification and other information is excluded from the screen S6. Alternatively, in this case, the information related to the construction at the manufacturing site among the specification and other information is highlighted on the screen S6, and the remaining information of the specification and other information is unhighlighted on the screen S6.

Further alternatively, for example in a case where the “Facility Manager” attribute is selected in the figure, information related to the building among the specification and other information is displayed on the screen S6, and the remaining information of the specification and other information is excluded from the screen S6. Alternatively, in this case, the information related to the building among the specification and other information is highlighted on the screen S6, and the remaining information of the specification and other information is unhighlighted on the screen S6.

Furthermore, the user interface control unit 48 causes check boxes CB52 for tag selection to be displayed in an area A52 on the screen S6. These check boxes CB52 are for selecting one or more tags which are targets of the search process by the sharing target information search unit 45 among the plurality of tags. That is, the operation of selecting one or more tags by the check boxes CB52 is also an operation of instructing execution of the search process.

The sharing target information search unit 45 searches for sharing target information to which the tag selected by the check boxes CB52 is attached from among the sharing target information in the sharing target information database 44 (more specifically, specification and other information). The user interface control unit 48 has a function of setting whether or not to display or a display mode of each piece of the specification and other information on the screen S6 depending on the result of the search process.

That is, the user interface control unit 48 includes, in the display target on the screen S6, information included in the result of the search process among the specification and other information, and excludes the remaining information of the specification and other information from the display target on the screen S6. Alternatively, the user interface control unit 48 causes the information included in the result of the search process among the specification and other information to be highlighted on the screen S6, and causes the remaining information of the specification and other information to be unhighlighted on the screen S6.

Note that the user interface control unit 48 may set whether or not to display or the display mode of each piece of the specification and other information on the screen S6 depending on the attribute selected by the check boxes CB51 and the result of the search process by the sharing target information search unit 45. As a result, for example, display as the following is implemented.

In the example illustrated in FIG. 13, the attribute “beginner” is selected in the check boxes CB51, and a tag “ele model xx” is selected in the check boxes CB52. In this case, the user interface control unit 48 causes information to which the tag that corresponds to the attribute “beginner” is attached and to which the tag “ele model xx” is attached among the specification and other information to be displayed on the screen S6, and excludes the remaining information from the screen S6. Alternatively, the user interface control unit 48 causes the information to which the tag that corresponds to the attribute “beginner” is attached and to which the tag “ele model xx” is attached among the specification and other information to be highlighted on the screen S6, and causes the remaining information to be unhighlighted on the screen S6.

Furthermore, the user interface control unit 48 may cause a button or the like (not illustrated) for instructing execution of the sort process to be displayed on the screen S6. The sharing target information sort unit 46 executes the sort process on the information included in the result of the search process in response to the operation of pressing the button. The user interface control unit 48 changes the arrangement order of the specification and other information on the screen S6 depending on the result of the sort process.

In addition, the on-site staff member can print the screen S6 on paper of a predetermined size (for example, A4 size) by using the printing machine 6. At this time, the on-site staff member can prepare a specification document or a manual book that is customized for each manufacturing site or for each on-site staff member by printing the screen S6 after execution of the search process and the sort process.

Therefore, the user interface control unit 48 may set the display layout of the screen S6 on the second terminal device 2 on the basis of the printed layout from the viewpoint of supporting preparation of these booklets. For example, the user interface control unit 48 sets the display layout of the screen S6 so that the check boxes CB52 are arranged at the end of each printed page. As a result, it is possible to improve the searchability of information in the printed booklet.

Moreover, the screen S6 may be displayed on another terminal device (not illustrated) for the on-site staff member in place of or in addition to the second terminal device 2. Furthermore, the screen S6 may be displayed on the display device 5 in place of or in addition to the second terminal device 2.

Furthermore, the user interface control unit 48 may change the display content on the screen S6 depending on the attribute selected by the check boxes CB51. For example, the user interface control unit 48 may cause an animation movie indicating basic information among the specification and other information to be reproduced on the screen S6 in a case where the attribute “beginner” is selected in the figure. Meanwhile, in a case where another attribute is selected, the user interface control unit 48 may cause the reproduction of the animation movie to be skipped.

Furthermore, the user interface illustrated in FIG. 13 (that is, the user interface by the screen S6) may be used in a screen for displaying any type of sharing target information as long as the screen displays the sharing target information in the sharing target information database 44.

For example, a screen for displaying a result of a theoretical examination may have a user interface similar to that illustrated in FIG. 13. That is, the screen for displaying the result of a theoretical examination is not limited to the specific example illustrated in FIG. 10. Alternatively, for example, a screen for displaying drawings and the like, that is, a screen for displaying various drawings, various lists, and various procedures may have a user interface similar to that illustrated in FIG. 13.

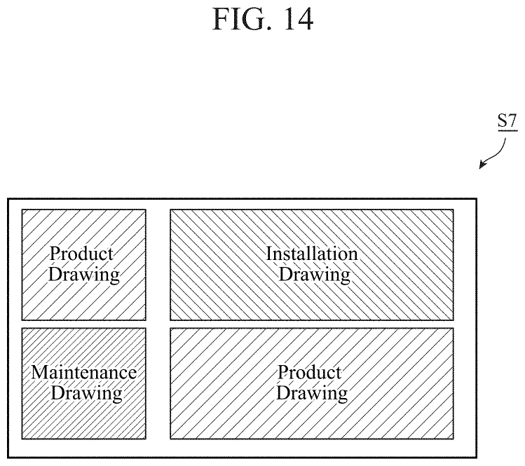

FIG. 14 is a diagram illustrating an example of a screen S7 for displaying various drawings in the first terminal device 1.

As described above, the developer prepares or acquires various drawings for development as well as prepares or acquires various drawings for manufacture and inputs information indicating these drawings (that is, drawing information) to the first terminal device 1. The user interface control unit 48 has a function of causing the screen S7 including one or more of these drawings (hereinafter, may be referred to as “display target drawings”) to be displayed on the first terminal device 1 when an operation instructing the display of the display target drawings is input to the first terminal device 1.

Here, as described above, the development division includes a plurality of departments. In a case where there is a plurality of display target drawings, there is a possibility that some of the display target drawings are useful for each of the plurality of departments, whereas the other drawings are not necessary.

Therefore, when each piece of drawing information is input, the tagging unit 42 attaches a tag indicating a corresponding department, among the plurality of departments, to the drawing information that has been input. At this time, the tagging unit 42 may automatically select a department that corresponds to each drawing (that is, a tag to be attached to each piece of drawing information) on the basis of a character string included in the piece of drawing information. Alternatively, for example, a check box for tag selection may be included in the screen for inputting each piece of drawing information, and a tag to be attached to the piece of drawing information may be selected by operation of the first inputter.

The user interface control unit 48 sets a display mode of or whether or not to display each of a plurality of display target drawings on the basis of a tag attached to each of the plurality of pieces of drawing information that corresponds to the plurality of display target drawings. As a result, for example, display as the following is implemented.

For example, the user interface control unit 48 causes a drawing that corresponds to a department in which the first terminal device 1 is installed (that is, the department to which the viewer of the screen S7 is likely to belong) among the plurality of display target drawings to be displayed in a different color from the remaining drawings. Alternatively, for example, the user interface control unit 48 causes the drawing that corresponds to a department in which the first terminal device 1 is installed among the plurality of display target drawings to be highlighted, and causes the remaining drawings to be unhighlighted. Further alternatively, for example, the user interface control unit 48 includes, in the screen S7, the drawing that corresponds to a department in which the first terminal device 1 is installed among the plurality of display target drawings, and excludes the remaining drawings from the screen S7. As a result, a viewer of the screen S7 can easily visually recognize a drawing related to the department to which the viewer belongs among the plurality of display target drawings.

Note that the screen S7 may be displayed on another terminal device (not illustrated) for the developer in place of or in addition to the first terminal device 1. Furthermore, the screen S7 may be displayed on a display device (not illustrated) for the developer in place of or in addition to the first terminal device 1.

FIG. 15 is a diagram illustrating an example of a screen S8 for recommending a review of specifications and the like in the first terminal device 1.

The control unit 32 has a function of counting the number of times of viewing and the number of times of printing by the on-site staff member for each piece of specification and other information in the sharing target information database 44.

Here, in a case where the number of times specific specification information is viewed is larger than the number of times other specification information is viewed, there is a possibility that the work related to an elevator or an article corresponding to the specific specification information is complicated or laborious for the on-site staff member or that the content or the format of the specific specification information is confusing for the on-site staff member. In addition, in a case where the number of times specific manual information is viewed is larger than the number of times other manual information is viewed, there is a possibility that the work based on the specific manual information is complicated or laborious for the on-site staff member or that the content or the format of the specific manual information is confusing for the on-site staff member. The same applies to the number of times of printing.

Therefore, the control unit 32 has a function of recommending the developer to review specifications and the like indicated by specification and other information when the specification and other information has a larger number of times of viewing or a larger number of times of printing than a predetermined number of times. At this time, the control unit 32 recommends the developer to also review specifications and the like indicated by specification and other information to which the same tag as the tag attached to the above specification and other information (for example, a tag indicating the same model, a tag indicating the same option, or a tag indicating the same construction state) is attached. It is intended to solve problems as described above by these reviews.

In addition, the control unit 32 has a function of counting the number of occurrences of defects for each predetermined condition (for example, for each elevator model, for each option of an elevator, or for each construction state of a building) by using the report information accumulated in the sharing target information database 44. The control unit 32 has a function of recommending the developer to review specifications and the like indicated by specification and other information to which a tag that corresponds to a condition having a larger number of occurrences of defects than a predetermined number is attached. The screen S8 illustrates an example of a screen that recommends a review in this case.

As mentioned above, the report information includes the picture of the place where the defect has occurred. As illustrated in FIG. 15, the screen S8 may include such pictures.

Furthermore, when the control unit 32 recommends a review of specifications or the like, the control unit 32 may calculate the cost-effectiveness of the review that is recommended. The user interface control unit 48 may include an image illustrating the cost-effectiveness that has been calculated on the screen S8.

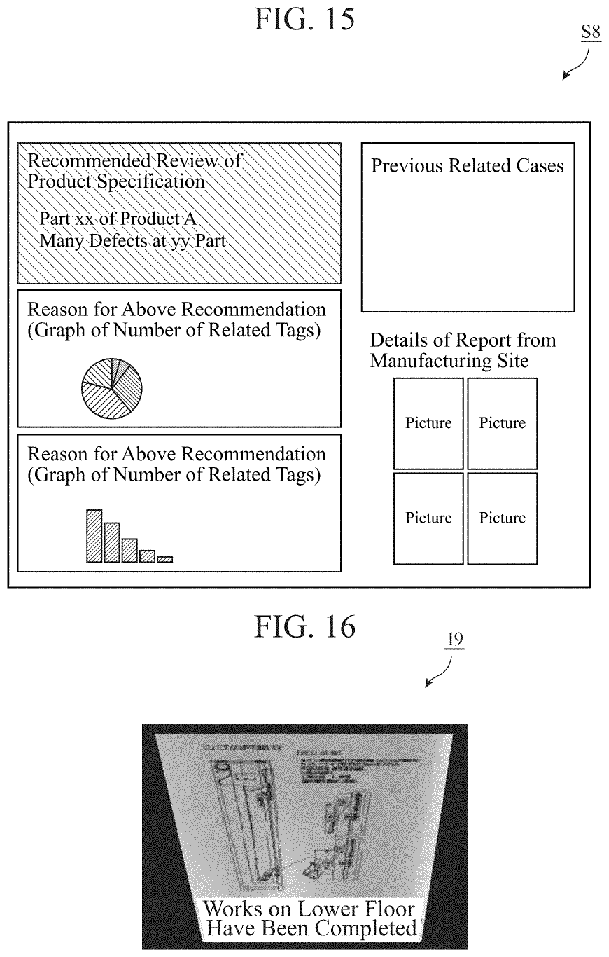

Next, an example of an image I9 that is projected by the projection device 7 will be described by referring to FIG. 16.

The control unit 32 determines the current manufacturing process at each manufacturing site by referring to schedule information or the like in the sharing target information database 44. The user interface control unit 48 instructs the projection device 7 to project the image I9 indicating information that corresponds to the manufacturing process that has been determined among the specification and other information in the sharing target information database 44. On the basis of the instruction, the projection device 7 projects the image I9 onto a wall surface of the car of the elevator or on a wall surface of the hoistway of the elevator. As a result, for example, it is possible to promote the sharing of specification and other information by a plurality of on-site staff members at each manufacturing site.

Note that the projection device 7 may project an image indicating any type of information as long as it is sharing target information in the sharing target information database 44. For example, the projection device 7 may project an image illustrating drawing information or the like that corresponds to the current manufacturing process. The on-site staff member can use the projected image to give various explanations to a client of the on-site staff member (for example, an architectural design office or the building owner) at the manufacturing site.

Next, other functions of the information sharing support system 200 will be described.

(1) The developer may revise specifications of each elevator or specifications of each article. The user interface control unit 48 may cause a button instructing execution of the batch update process to be displayed on an input screen of specification information indicating the revised specifications. When the button is pressed, the sharing target information update unit 47 may update the specification information corresponding to the revised specifications and may execute the batch update process on information related to the elevator or the article, specifications of which have been revised, among the sharing target information in the sharing target information database 44.

(2) When a screen is displayed in which specification information before revision and specification information after revision are mixed, the user interface control unit 48 may cause the specification information before revision to be unhighlighted and cause the specification information after revision to be highlighted.

(3) The second terminal device 2 may automatically read out, on each day during the manufacture, information related to precautions in the manufacturing process of the day and information related to safety confirmation items.

(4) When an article to be used for the manufacture of an elevator enters the field of view of the on-site staff member wearing smart glasses (that is, the second terminal device 2), an HUD of the smart glasses may automatically perform augmented reality (AR) display in such a manner as to emphasize the article (for example, AR display that frames the article). At the same time, information indicating manufacturing processes before and after the manufacturing process in which the article is used may be displayed on the HUD or may be automatically read out by the second terminal device 2.

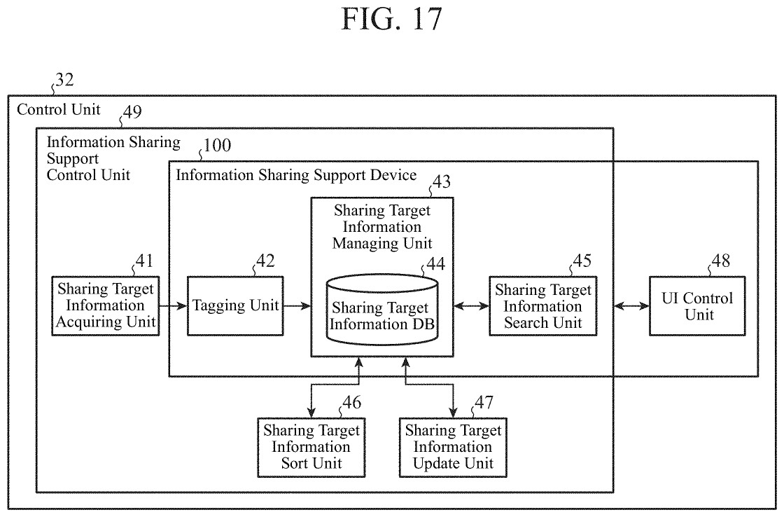

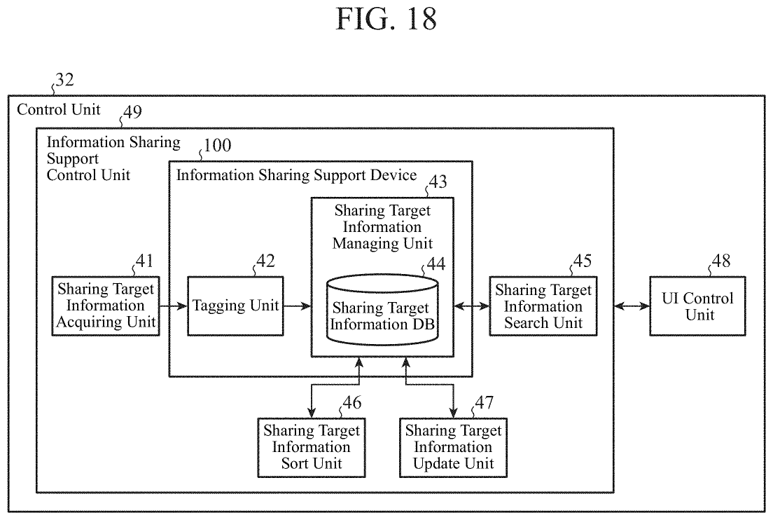

Next, modifications of the information sharing support device 100 will be described by referring to FIGS. 17 to 18.

Each of the sharing target information acquiring unit 41, the sharing target information sort unit 46, and the sharing target information update unit 47 may be provided outside the information sharing support device 100 in the control unit 32. As a result, for example as illustrated in FIG. 17, the tagging unit 42, the sharing target information managing unit 43, the sharing target information search unit 45, and the user interface control unit 48 may be included in the main part of the information sharing support device 100. Alternatively, for example as illustrated in FIG. 18, the tagging unit 42 and the sharing target information managing unit 43 may be included in the main part of the information sharing support device 100.

Next, modifications of the information sharing support system 200 will be described.

At least some of the functions of the sharing target information acquiring unit 41, the tagging unit 42, the sharing target information managing unit 43, the sharing target information search unit 45, the sharing target information sort unit 46, the sharing target information update unit 47, and the user interface control unit 48 may be implemented by the control unit 12 of the first terminal device 1 instead of the control unit 32 of the server device 3. Furthermore, at least some of these functions may be implemented by the control unit 22 of the second terminal device 2 instead of the control unit 32 of the server device 3.

Furthermore, the manufacturing target apparatus is not limited to elevators and may be any apparatus.

As described above, the information sharing support device 100 of the first embodiment supports sharing of a plurality of pieces of sharing target information related to the development and the manufacture of a manufacturing target apparatus. The information sharing support device 100 includes the tagging unit 42 for attaching a tag selected from a plurality of tags to each of the plurality of pieces of sharing target information; and the sharing target information managing unit 43 for managing the plurality of pieces of sharing target information in association with each other on the basis of the tag attached to each of the plurality of pieces of sharing target information. The plurality of pieces of sharing target information includes basic sharing target information and additional sharing target information that is additionally input to the basic sharing target information by a staff member at a manufacturing site (on-site staff member) of the manufacturing target apparatus. A tag attached to the additional sharing target information includes a tag attached to the basic sharing target information that corresponds to the additional sharing target information. As a result, it is possible to promote sharing of sharing target information between the developer and the on-site staff member. In particular, information prepared or acquired at the manufacturing site (that is, additional sharing target information) can be shared between the developer and the on-site staff member. In addition, another on-site staff member can also share these pieces of information. Moreover, by using the tags, it is possible to improve the searchability of sharing target information.

Furthermore, the tagging unit 42 has a function of automatically selecting a tag to be attached to each of the plurality of pieces of sharing target information. As a result, for example, it is possible to eliminate the need of operation of selecting a tag by the on-site staff member at the manufacturing site.

Furthermore, the information sharing support device 100 includes the user interface control unit 48 for executing control for displaying the screen S6 including the plurality of pieces of sharing target information on a terminal device (second terminal device 2) or the display device 5 for the staff member (on-site staff member), and, on the screen S6, the plurality of pieces of sharing target information is arranged in an order based on a manufacturing process of the manufacturing target apparatus on the basis of the tag attached to each of the plurality of pieces of sharing target information. As a result, for example, it is possible to implement the user interface illustrated in FIG. 13.

Furthermore, the information sharing support device 100 includes the sharing target information search unit 45 for executing the search process on the plurality of pieces of sharing target information on the basis of the tag attached to each of the plurality of pieces of sharing target information, and the user interface control unit 48 sets a display mode of or whether or not to display each of the plurality of pieces of sharing target information on the screen S6 depending on a result of the search process. As a result, it is possible to improve the viewability of the screen S6 depending on the result of the search process.

In addition, the screen S6 includes the check boxes CB52 for selecting a tag which is a target of the search process among a plurality of tags. As a result, a viewer of the screen S6 can easily select the tag which is the target of the search process.

Furthermore, the screen S6 includes the check boxes CB51 for selecting an attribute of a viewer of the screen S6, and the user interface control unit 48 sets a display mode of or whether or not to display each of the plurality of pieces of sharing target information on the screen S6 depending on a tag that corresponds to the attribute selected by the check boxes CB51 among the plurality of tags. As a result, it is possible to improve the viewability of the screen S6 depending on the attribute of the viewer of the screen S6.

Moreover, the information sharing support system 200 of the first embodiment supports sharing of a plurality of pieces of sharing target information related to the development and the manufacture of a manufacturing target apparatus. The information sharing support system 200 includes the tagging unit 42 for attaching a tag selected from a plurality of tags to each of the plurality of pieces of sharing target information; and the sharing target information managing unit 43 for managing the plurality of pieces of sharing target information in association with each other on the basis of the tag attached to each of the plurality of pieces of sharing target information. The plurality of pieces of sharing target information includes basic sharing target information and additional sharing target information that is additionally input to the basic sharing target information by a staff member at a manufacturing site (on-site staff member) of the manufacturing target apparatus. A tag attached to the additional sharing target information includes a tag attached to the basic sharing target information that corresponds to the additional sharing target information. As a result, similar effects to the above-described effects by the information sharing support device 100 can be obtained.

### Second Embodiment

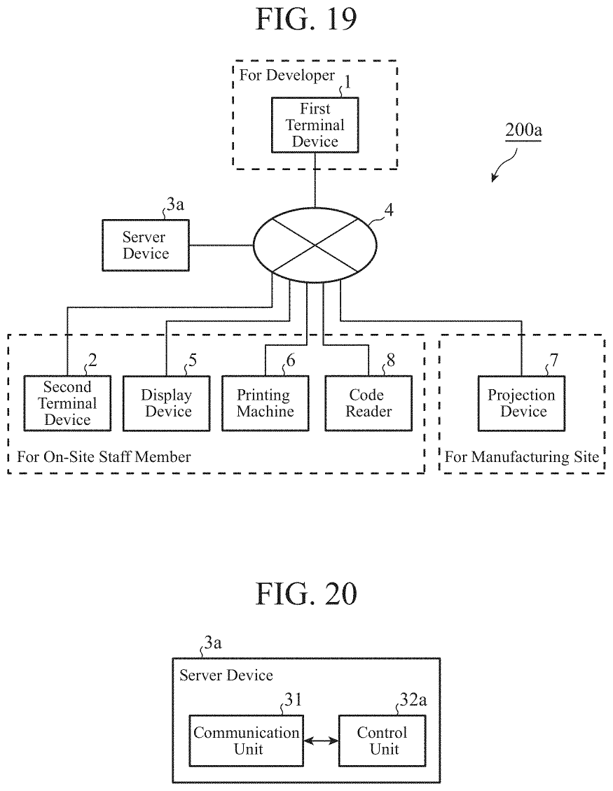

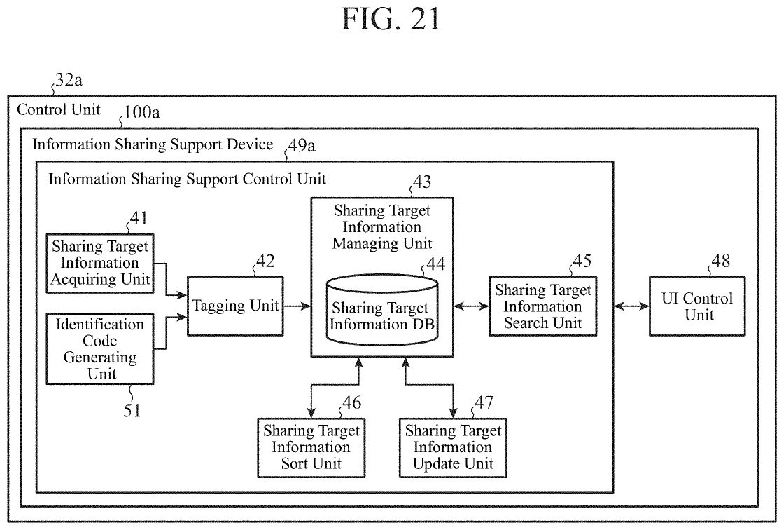

FIG. 19 is an explanatory diagram illustrating a system configuration of an information sharing support system according to a second embodiment. FIG. 20 is a block diagram illustrating a main part of a server device included in the information sharing support system according to the second embodiment. FIG. 21 is a block diagram illustrating a main part of an information sharing support device according to the second embodiment. An information sharing support device 100a and an information sharing support system 200a of the second embodiment will be described by referring to FIGS. 19 to 21.

Note that in FIG. 19 the same symbol is given to a component similar to a component illustrated in FIG. 1, and description thereof is omitted. Furthermore, since the configuration of a first terminal device 1 included in the information sharing support system 200a is similar to that described by referring to FIG. 2 in the first embodiment, illustration and description will be omitted. Likewise, since the configuration of a second terminal device 2 included in the information sharing support system 200a is similar to that described by referring to FIG. 3 in the first embodiment, illustration and description will be omitted. Note that in FIG. 20 the same symbol is given to a block similar to a block illustrated in FIG. 4, and description thereof is omitted. Note that in FIG. 21 the same symbol is given to a block similar to a block illustrated in FIG. 5, and description thereof is omitted.

As illustrated in FIG. 19, the information sharing support system 200a may include a code reader 8 for an on-site staff member. The code reader 8 includes, for example, a reader for a one-dimensional code such as a barcode, a reader for a two-dimensional code such as a QR code (registered trademark), or a reader for a three-dimensional code such as a PM code (registered trademark). The code reader 8 can freely communicate with a server device 3a by the computer network 4. Note that the code reader 8 may freely communicate with the server device 3a via the second terminal device 2.

As illustrated in FIG. 21, the information sharing support device 100a includes an identification code generating unit 51. The identification code generating unit 51 generates, for each article (jigs, tools, parts, etc.) to be used in the manufacture of each elevator, a one-dimensional code for identification, a two-dimensional code for identification, or a three-dimensional code for identification (hereinafter collectively referred to as an “identification code”).

In the information sharing support system 200a, information indicating each identification code generated by the identification code generating unit 51 (hereinafter referred to as “identification code information”) is stored in the sharing target information database 44 as sharing target information. That is, the tagging unit 42 attaches a tag indicating a corresponding article to each piece of identification code information.

Usually, each article is shipped to a corresponding manufacturing site by a manufacturer or a trading company that handles the article (hereinafter collectively referred to as a “sender”). At this point, the sender of each article is notified of an identification code indicating the corresponding article by the developer. The sender of each article attaches the notified identification code when shipping the corresponding article. Alternatively, the sender of each article affixes the notified identification code to a packing material (for example, a wooden box or a cardboard) when shipping the corresponding article.

When each article is delivered to the manufacturing site, the on-site staff member reads the attached or affixed identification code using the imaging unit 26 of the second terminal device 2 or the code reader 8. The second terminal device 2 or the code reader 8 transmits identification code information indicating the identification code that has been read and other information to the server device 3a. In response to this, a control unit 32a extracts information related to the article indicated by the identification code that has been read (that is, information to which the tag indicating the article is attached) from the sharing target information in the sharing target information database 44. The user interface control unit 48 executes control for displaying a screen including at least a part of the information that has been extracted on the second terminal device 2.

For example, the user interface control unit 48 causes a screen including information indicating the article to be displayed on the second terminal device 2. As a result, in a case where the identification code is affixed to the packing material, the on-site staff member can know the content of the packing without opening the packing packed by the packing material. As a result, it is possible to prevent occurrence of unnecessary opening work at the manufacturing site.

Furthermore, for example, the user interface control unit 48 causes a screen including information indicating the specifications of the article to be displayed on the second terminal device 2. As a result, the on-site staff member can know the latest specifications of the article.

Conventionally, an article and a specification document indicating the specifications of the article are shipped separately. Therefore, there is a problem that there are cases where a specification document describing specifications before revision is shipped even though the specifications of the article have been revised, due to a difference between the shipping timing of the article and the shipping timing of the specification document. The information sharing support system 200a can solve such a problem.

Furthermore, for example, the user interface control unit 48 causes a screen including information indicating a manual of work using the article, information indicating the date and time when the work using the article is scheduled to be performed, information indicating a manufacturing process in which the article is used, or the like to be displayed on the second terminal device 2. This allows the on-site staff member to know these pieces of information.

The sharing target information acquiring unit 41, the tagging unit 42, the sharing target information managing unit 43, the sharing target information search unit 45, the sharing target information sort unit 46, the sharing target information update unit 47, and the identification code generating unit 51 are included in the main part of an information sharing support control unit 49a. The user interface control unit 48 and the information sharing support control unit 49a are included in the main part of the control unit 32a. Meanwhile, the user interface control unit 48 and the information sharing support control unit 49a are included in the main part of the information sharing support device 100a. The communication unit 31 and the control unit 32a are included in the main part of the server device 3a.

Since the hardware configuration of the main part of the information sharing support device 100a is similar to that described by referring to FIG. 6 in the first embodiment, illustration and description thereof are omitted. That is, the function of the identification code generating unit 51 may be implemented by the processor 61 and the memory 62 or may be implemented by the dedicated processing circuit 64.

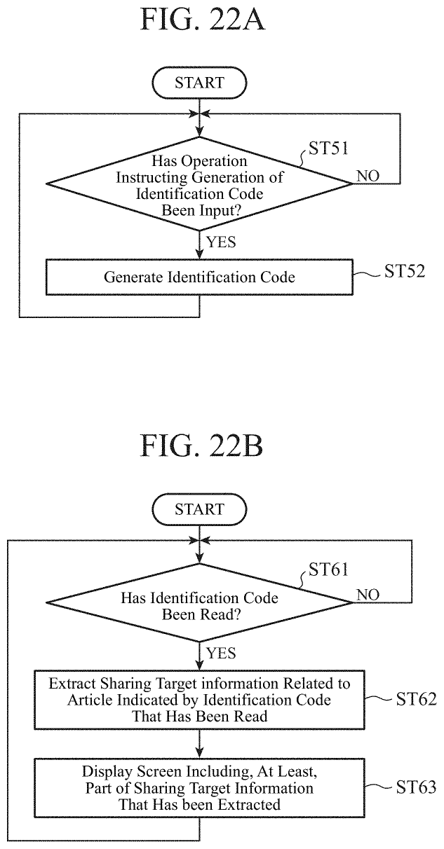

Next, the operation of the information sharing support device 100a will be described by referring to flowcharts of FIG. 22.

FIG. 22A illustrates the operation of the identification code generating unit 51. As illustrated in FIG. 22A, if an operation instructing generation of an identification code is input to the first terminal device 1 (for example, on a screen for inputting information related to each article, a button instructing generation of an identification code is pressed) (“YES” in step ST51), the identification code generating unit 51 generates an identification code indicating a corresponding article (step ST52).

FIG. 22B is a diagram illustrating the operation of the user interface control unit 48 and other components. As illustrated in FIG. 22B, if an identification code indicating one of a plurality of articles is read by the second terminal device 2 or the code reader 8 (“YES” in step ST61), the control unit 32a extracts information related to the article indicated by the identification code that has been read (that is, information to which a tag indicating the article is attached) from the sharing target information in the sharing target information database 44 (step ST62). Next, the user interface control unit 48 executes control for displaying a screen including at least a part of the information that has been extracted (for example specification information) on the second terminal device 2 (step ST63).

Note that the information sharing support device 100a can adopt various modifications similar to those described in the first embodiment.

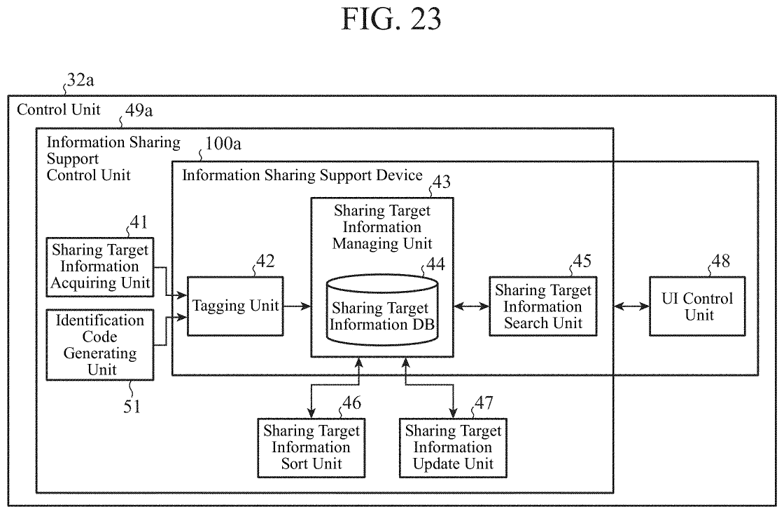

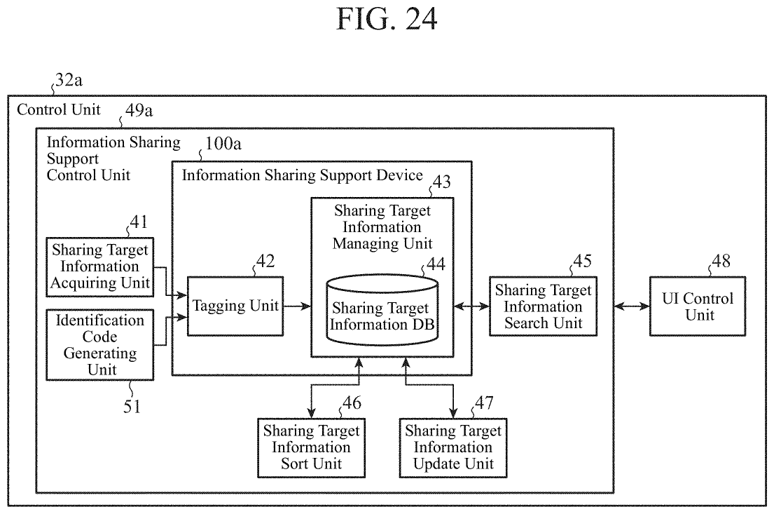

For example, each of the sharing target information acquiring unit 41, the sharing target information sort unit 46, the sharing target information update unit 47, and the identification code generating unit 51 may be provided outside the information sharing support device 100a in the control unit 32a. As a result, as illustrated in FIG. 23, the tagging unit 42, the sharing target information managing unit 43, the sharing target information search unit 45, and the user interface control unit 48 may be included in the main part of the information sharing support device 100a. Alternatively, as illustrated in FIG. 24, the tagging unit 42 and the sharing target information managing unit 43 may be included in the main part of the information sharing support device 100a.

In addition, the information sharing support system 200a can adopt various modifications similar to those described in the first embodiment.

For example, at least some of the functions of the sharing target information acquiring unit 41, the tagging unit 42, the sharing target information managing unit 43, the sharing target information search unit 45, the sharing target information sort unit 46, the sharing target information update unit 47, the user interface control unit 48, and the identification code generating unit 51 may be implemented by the control unit 12 of the first terminal device 1 instead of the control unit 32a of the server device 3a. Furthermore, at least some of these functions may be implemented by the control unit 22 of the second terminal device 2 instead of the control unit 32a of the server device 3a.

As described above, in the information sharing support device 100a of the second embodiment, the plurality of pieces of sharing target information includes information indicating a plurality of identification codes that corresponds to a plurality of articles to be used in the manufacture of the manufacturing target apparatus (identification code information). The information sharing support device 100a includes the user interface control unit 48 for executing control for displaying, on the terminal device (second terminal device 2), when any one of the identification codes is read by the terminal device (second terminal device 2) or the code reader 8 for the staff member (on-site staff member), a screen including information related to an article that corresponds to the identification code that is read among the plurality of pieces of sharing target information, on the basis of the tag attached to each of the plurality of pieces of sharing target information. As a result, it is possible to prevent occurrence of unnecessary opening work at the manufacturing site. In addition, the on-site staff member can know the latest specifications.

Note that the present invention may include a flexible combination of the embodiments, a modification of any component of the embodiments, or an omission of any component in the embodiments within the scope of the present invention.

### INDUSTRIAL APPLICABILITY

An information sharing support device and an information sharing support system of the present invention can be used, for example, for the development and the manufacture of an elevator.

### REFERENCE SIGNS LIST

1: first terminal device, 2: second terminal device, 3, 3a: server device, 4: computer network, 5: display device, 6: printing machine, 7: projection device, 8: code reader, 11: communication unit, 12: control unit, 13: operation input unit, 14: display unit, 21: communication unit, 22: control unit, 23: operation input unit, 24: display unit, 25: audio output unit, 26: imaging unit, 31: communication unit, 32, 32a: control unit, 41: sharing target information acquiring unit, 42: tagging unit, 43: sharing target information managing unit, 44: sharing target information database (sharing target information DB), 45: sharing target information search unit, 46: sharing target information sort unit, 47: sharing target information update unit, 48: user interface control unit (UI control unit), 49, 49a: information sharing support control unit, 51: identification code generating unit, 61: processor, 62: memory, 63: memory, 64: processing circuit, 100, 100a: information sharing support device, 200, 200a: information sharing support system

1. An information sharing support device for supporting sharing of a plurality of pieces of sharing target information related to development and manufacture of a manufacturing target apparatus, the information sharing support device comprising:
processing circuitry
to attach a tag selected from a plurality of tags to each of the plurality of pieces of sharing target information; and
to manage the plurality of pieces of sharing target information in association with each other on a basis of the tag attached to each of the plurality of pieces of sharing target information,
wherein the plurality of pieces of sharing target information includes basic sharing target information and additional sharing target information that is additionally input to the basic sharing target information by a staff member at a manufacturing site of the manufacturing target apparatus, and
a tag attached to the additional sharing target information includes a tag attached to the basic sharing target information that corresponds to the additional sharing target information.

2. The information sharing support device according to claim 1, wherein the basic sharing target information includes information input by a developer of the manufacturing target apparatus.

3. The information sharing support device according to claim 1, wherein the plurality of tags includes an initial tag that is prestored and an additional tag generated by the processing circuitry.

4. The information sharing support device according to claim 1, wherein the processing circuitry has a function of automatically selecting a tag to be attached to each of the plurality of pieces of sharing target information.

5. The information sharing support device according to claim 1,
wherein the processing circuitry executes control for displaying a screen including the plurality of pieces of sharing target information on a terminal device or a display device for the staff member, and
on the screen, the plurality of pieces of sharing target information is arranged in an order based on a manufacturing process of the manufacturing target apparatus on a basis of the tag attached to each of the plurality of pieces of sharing target information.

6. The information sharing support device according to claim 5,
wherein the processing circuitry executes a search process on the plurality of pieces of sharing target information on a basis of the tag attached to each of the plurality of pieces of sharing target information, and
the processing circuitry sets a display mode of or whether or not to display each of the plurality of pieces of sharing target information on the screen depending on a result of the search process.

7. The information sharing support device according to claim 6, wherein the screen includes a check box for selecting a tag that is a target of the search process among the plurality of tags.

8. The information sharing support device according to claim 5,
wherein the screen includes a check box for selecting an attribute of a viewer of the screen, and
the processing circuitry sets a display mode of or whether or not to display each of the plurality of pieces of sharing target information on the screen depending on a tag that corresponds to the attribute selected by the check box among the plurality of tags.

9. The information sharing support device according to claim 1,
wherein the plurality of pieces of sharing target information includes information indicating a plurality of identification codes that corresponds to a plurality of articles to be used in the manufacture of the manufacturing target apparatus, and
the processing circuitry executes control for displaying, on a terminal device for the staff member, when any one of the identification codes is read by the terminal device or a code reader for the staff member, a screen including information related to one of the articles that corresponds to the one of the identification codes that has been read among the plurality of pieces of sharing target information, on a basis of the tag attached to each of the plurality of pieces of sharing target information.

10. An information sharing support system for supporting sharing of a plurality of pieces of sharing target information related to development and manufacture of a manufacturing target apparatus, the information sharing support system comprising:
processing circuitry
to attach a tag selected from a plurality of tags to each of the plurality of pieces of sharing target information; and
to manage the plurality of pieces of sharing target information in association with each other on a basis of the tag attached to each of the plurality of pieces of sharing target information,
wherein the plurality of pieces of sharing target information includes basic sharing target information and additional sharing target information that is additionally input to the basic sharing target information by a staff member at a manufacturing site of the manufacturing target apparatus, and
a tag attached to the additional sharing target information includes a tag attached to the basic sharing target information that corresponds to the additional sharing target information.
